(19) United States
(12) Patent Application Publication
(10) Pub. No.: US 2016/0149601 A1
(43) Pub. Date: May 26, 2016

(54) WIRELESS POWER RECEIVER DEVICE AND WIRELESS COMMUNICATIONS DEVICE

(71) Applicant: MediaTek Inc., Hsin-Chu (TW)

(72) Inventors: Fu-Chi LIN, Hsinchu City (TW); Chi-Min LEE, Zhubei City (TW); William PLUMB, Charlestown, MA (US)

(21) Appl. No.: 14/873,615

(22) Filed: Oct. 2, 2015

Related U.S. Application Data
(60) Provisional application No. 62/082,675, filed on Nov. 21, 2014.

(51) Int. Cl. H04B 1/10; H04W 4/00; H02J 5/00

(52) U.S. Cl. CPC H04B 1/1018; H02J 5/005; H04W 4/008

(57) ABSTRACT

A wireless power receiver device capable of performing wireless power reception includes a processor and a communications module. The processor determines a delay time and generates a delay control signal including information regarding the delay time. The communications module is coupled to the processor and capable of providing wireless communications service. The communications module receives the delay control signal and delays a time to transmit a first packet utilized for establishing communication between the wireless power receiver device and a wireless power transmitter device according to the delay time.

### CROSS REFERENCE TO RELATED APPLICATIONS

This application claims the benefit of U.S. Provisional Application No. 62/082,675 filed on Nov. 21, 2014 and entitled “Method for Preventing A4WP BLE Advertising Packet Collision”, the entire contents of which are hereby incorporated by reference.

### BACKGROUND OF THE INVENTION

1. Field of the Invention

The invention relates to a device and a method to reduce the possibility of packet collision, and more particularly to a device and a method to reduce the possibility of packet collision when engaging a wireless power transmitter and a plurality of wireless power receivers.

2. Description of the Related Art

There are several methods of wireless power transmission, of which magnetic induction and magnetic resonance are two of the most common. Magnetic induction basically adopts an induction coil at both the wireless power transmitter and the wireless power receiver. When power is provided to the transmitter coil, the electromagnetic effect is generated since the current generates the magnetism and the magnetism generates the current. When the receiver coil receives the electromagnetic signal, power is generated via the magnetic field change so as to charge the battery. The principle of magnetic resonance is different from magnetic induction that uses mutual induction to exchange electromagnetic power. For magnetic resonance, the charger dock and the object to be charged use the same frequency so that the power can be efficiently transmitted therebetween by resonance. When the wireless power transmitter and the wireless power receiver resonate at the same frequency, the wireless power receiver receives the electromagnetic field generated by the wireless power transmitter, thereby receiving the power from the wireless power transmitter.

To facilitate wireless power transmission, a Bluetooth Low Energy (BLE) technology is further adopts to establish a BLE connection between the transmitter and the receiver for communication. For example, the receiver may inform the transmitter about its power requirement via the BLE connection. However, when collision in the BLE advertising packet occurs, the BLE connection cannot be established successfully. Therefore, a device and a method to avoid BLE advertising packet collision are urgently required.

### BRIEF SUMMARY OF THE INVENTION

A wireless power receiver device and a wireless communications device are provided. An exemplary embodiment of a wireless power receiver device capable of performing wireless power reception comprises a processor and a communications module. The processor determines a delay time and generates a delay control signal comprising information regarding the delay time. The communications module is coupled to the processor and capable of providing wireless communications service. The BLE module receives the delay control signal and delays a time to transmit a first packet utilized for establishing communications between the wireless power receiver device and a wireless power transmitter device according to the delay time.

An exemplary embodiment of a wireless power receiver device capable of performing wireless power reception and communicating with a communications device comprises: an analog-to-digital converter (ADC). The ADC generates a digital signal according to an analog voltage. The digital signal or a tick time value generated from a timer is utilized to determine a delay time for the communication device to delay a time to transmit a first packet utilized for establishing communication between the wireless power receiver device and a wireless power transmitter device.

An exemplary embodiment of a wireless communications device capable of providing wireless communications service and coupled to a wireless power receiver device to facilitate the wireless power receiver device to establish a wireless communications with a wireless power transmitter device comprises a processor and a communications module. The processor generates a delay control signal comprising information regarding a delay time. The BLE module is coupled to the processor and capable of providing wireless communications service. The communications module receives the delay control signal and delays a time to transmit a first packet utilized for establishing communications between the wireless power receiver device and the wireless power transmitter device according to the delay time. The first packet is transmitted in response to a beacon frame received from the wireless power transmitter device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram showing a wireless charging system according to an embodiment of the invention;

FIG. 2 is a schematic diagram showing signals transmitted by a wireless power transmitter device according to an embodiment of the invention;

FIG. 3 is a schematic diagram showing signals transmitted by a wireless power receiver device according to an embodiment of the invention;

FIG. 4 is a block diagram of a wireless power receiver device according to an embodiment of the invention;

FIG. 5 is a block diagram of a wireless power receiver device according to another embodiment of the invention;

FIG. 6 is a block diagram of a wireless power receiver device according to yet another embodiment of the invention; and

FIG. 7 shows the timing diagrams for different power receiving units to transmit the advertising packets according an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

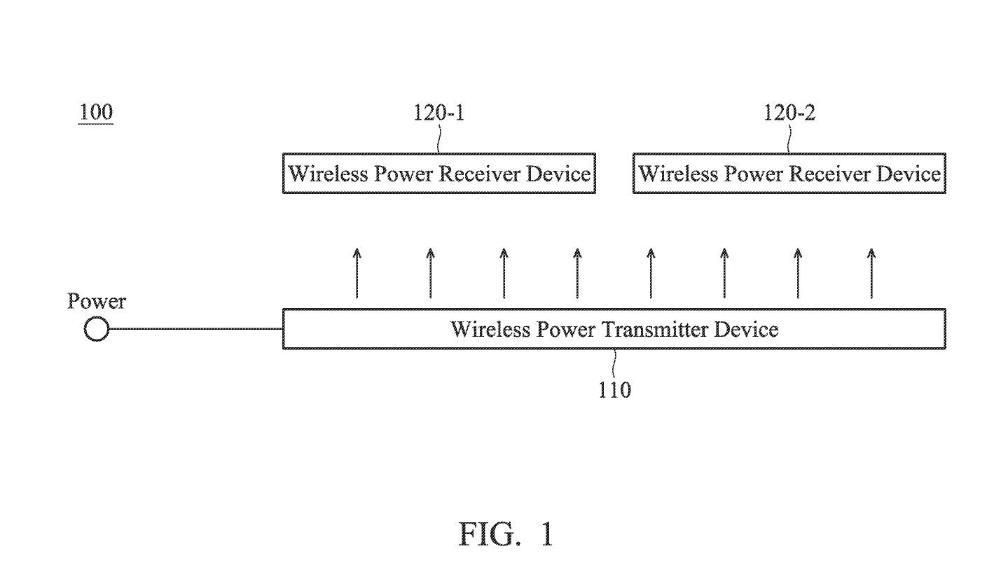

FIG. 1 is a schematic diagram showing a wireless charging system according to an embodiment of the invention. The wireless charging system 100 may comprise a wireless power transmitter device 110. The wireless power transmitter device 110 is coupled to a power source and comprises a coil (or a resonator) (not shown) to provide power to the air interface. When any object needs to be charged, it can be placed in a position close to the wireless power transmitter device 110 to receive wireless power. For example, the wireless charging system 100 may further comprise wireless power receiver devices 120-1 and 120-2 to be charged.

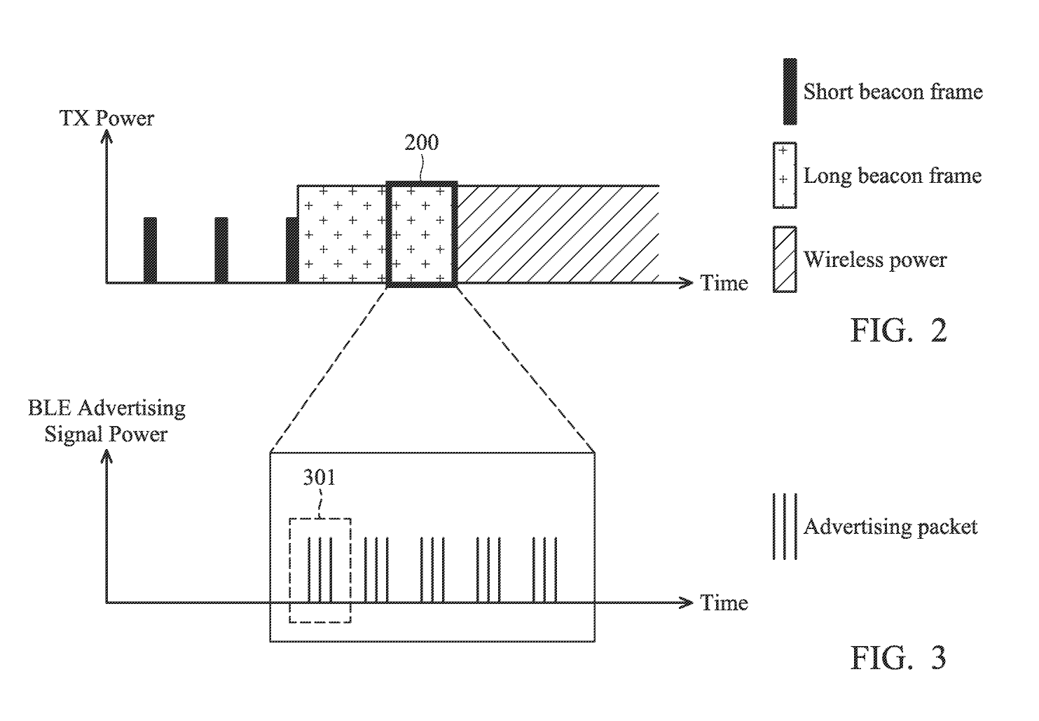

FIG. 2 is a schematic diagram showing signals transmitted by a wireless power transmitter device according to an embodiment of the invention. FIG. 3 is a schematic diagram showing signals transmitted by a wireless power receiver device according to an embodiment of the invention. The wireless power transmitter device may transmit one or more short beacon frames to detect whether any wireless power receiver device exists. When the wireless power transmitter device detects any wireless power receiver device exists, the wireless power transmitter device may transmit a long beacon frame, which may have a length of 100 ms or more, to try to engage with the wireless power receiver device. The wireless power receiver device may use the power provided by the wireless power transmitter device during the long beacon frame period to power on (boot) and then transmit one or more advertising packets to the wireless power transmitter device in the advertisement period 200 for establishing communications between the wireless power receiver device and the wireless power transmitter device.

The advertising packet may comprise information regarding the wireless power receiver device, such as the device name, the manufactory and specification of the wireless power receiver device, and so on. When the wireless power transmitter device receives the advertising packet, the wireless power transmitter device may pair with the wireless power receiver device and establish a wireless connection, such as a Bluetooth Low Energy (BLE) connection, between the wireless power transmitter device and the wireless power receiver device. The wireless power transmitter device and the wireless power receiver device may communicate via the wireless connection to facilitate wireless power transmission. For example, the wireless power receiver device may inform the wireless power transmitter device about its power requirement via the BLE connection.

When there are more than one wireless power receiver device to be charged in the wireless charging system, these wireless power receiver devices may boot concurrently since they receive the same beacon frame from the same wireless power transmitter device. In this manner, collision in the BLE advertising packet may occur. When collision occurs, the BLE connection cannot be established successfully. To solve this problem, several devices and methods to avoid advertising packet collision are provided.

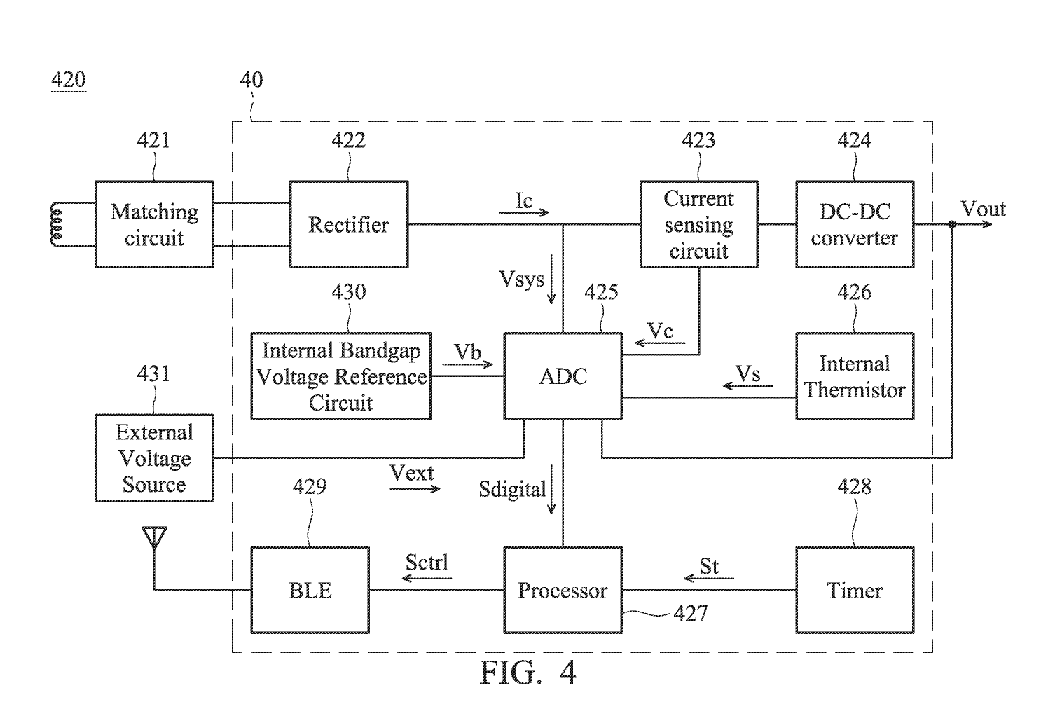

FIG. 4 is a block diagram of a wireless power receiver device according to an embodiment of the invention. The wireless power receiver device 420 is capable of performing wireless power reception and may comprise a coil or resonator to receive power from the air interface and a matching circuit 421 coupled to the coil or resonator to provide impedance matching. The wireless power receiver device 420 may further comprise a rectifier 422, a current sensing circuit 423, a DC-DC converter 424, an analog-to-digital converter (ADC) 425, an internal thermistor 426, a processor 427, a timer 428, a communications module, such as a BLE module 429, an internal bandgap voltage reference circuit 430 and an external voltage source 431.

The rectifier 422 may receive the inducing current from the matching circuit 421 and rectify the inducing current to generate a system voltage Vsys and a corresponding current signal as a charging current Ic. The current sensing circuit 423 may receive the charging current Ic and senses an amount of the charging current Ic to generate a corresponding sensed voltage Vc. The DC-DC converter 424 may further converter the system voltage Vsys into an output voltage Vout so as to provide power to a device or a following stage of circuit coupled to the wireless power receiver device 420. The internal thermistor 426 may sense an internal temperature of the wireless power receiver device 420 to generate another sensed voltage Vs. The ADC 425 may receive the voltage signals, such as the system voltage Vsys, the sensed voltage Vc and the sensed voltage Vs, which may be analog voltages, and analog-to-digital convert the voltage signals to generate a corresponding digital signal Sdigital. The timer 428 may provide a timer signal St comprising information regarding a current tick time value to the processor 427. The BLE module 429 may provide BLE communications service. The processor 427 may be coupled to a plurality of elements of the wireless power receiver device 420 and control the operations thereof.

According to an embodiment of the invention, the processor 427 may determine a delay time Δt and generate a delay control signal Sctrl comprising information regarding the delay time Δt. The BLE module 429 may receive the delay control signal Sctrl from the processor 427 and delay a time to transmit a first advertising packet, such as the advertising packet 301 shown in FIG. 3, according to the delay time Δt. For example, after the wireless power receiver device 420 is powered on, the BLE module 429 may wait for Δt milliseconds and then transmit the first advertising packet. As previously described, the first advertising packet is transmitted in response to a beacon frame received from a wireless power transmitter device, where the beacon frame is the long beacon frame.

In the embodiments of the invention, the processor 427 may determine a delay time Δt randomly, pseudo-randomly, or non-randomly.

According to an embodiment of the invention, the processor 427 may determine the delay time Δt according to the digital signal Sdigital provided by the ADC 425. According to another embodiment of the invention, the processor 427 may also determine the delay time Δt according to the timer signal St provided by the timer 428. For example, the processor 427 may take the value of the digital signal Sdigital or the current tick time value of the timer 428 as a parameter of a predetermined algorithm or equation to calculate a delay time Δt. For another example, the processor 427 may also use the value of the digital signal Sdigital or the current tick time value of the timer 428 as a random seed and generate a random/pseudo-random number as the delay time Δt according to the random seed.

To be more specific, according to an embodiment of the invention, the processor 427 may use the output of the rectifier 422, such as the system voltage Vsys or its ADC result, as a parameter of a predetermined algorithm or equation to calculate a delay time Δt, or as a random seed and generate a random/pseudo-random number as the delay time Δt according to the random seed.

According to another embodiment of the invention, the processor 427 may use the output of the current sensing circuit 423, such as the sensed voltage Vc or its ADC result, as a parameter of a predetermined algorithm or equation to calculate a delay time Δt, or as a random seed and generate a random/pseudo-random number as the delay time Δt according to the random seed.

According to yet another embodiment of the invention, the processor 427 may use the output of the internal thermistor 426, such as the sensed voltage Vs or its ADC result, as a parameter of a predetermined algorithm or equation to calculate a delay time Δt, or as a random seed and generate a random/pseudo-random number as the delay time Δt according to the random seed.

According to yet another embodiment of the invention, the processor 427 may use the output of the internal bandgap voltage reference circuit 430, such as the bandgap voltage Vb or its ADC result, as a parameter of a predetermined algorithm or equation to calculate a delay time Δt, or as a random seed and generate a random/pseudo-random number as the delay time Δt according to the random seed.

According to yet another embodiment of the invention, the processor 427 may use the output of the external voltage reference 431, such as the external voltage Vext or its ADC result, as a parameter of a predetermined algorithm or equation to calculate a delay time Δt, or as a random seed and generate a random/pseudo-random number as the delay time Δt according to the random seed.

According to still another embodiment of the invention, the processor 427 may use the output of the timer 428, such as the current tick time value of the timer 428, as a parameter of a predetermined algorithm or equation to calculate a delay time Δt, or as a random seed and generate a random/pseudo-random number as the delay time Δt according to the random seed.

Note that in some embodiments of the invention, the rectifier 422, the current sensing circuit 423, the DC-DC converter 424, the ADC 425, the internal thermistor 426, the processor 427, the timer 428, the BLE module 429 and the internal bandgap voltage reference circuit 430 may all be integrated in one chip, such as the wireless power receiver chip 40 shown in FIG. 4.

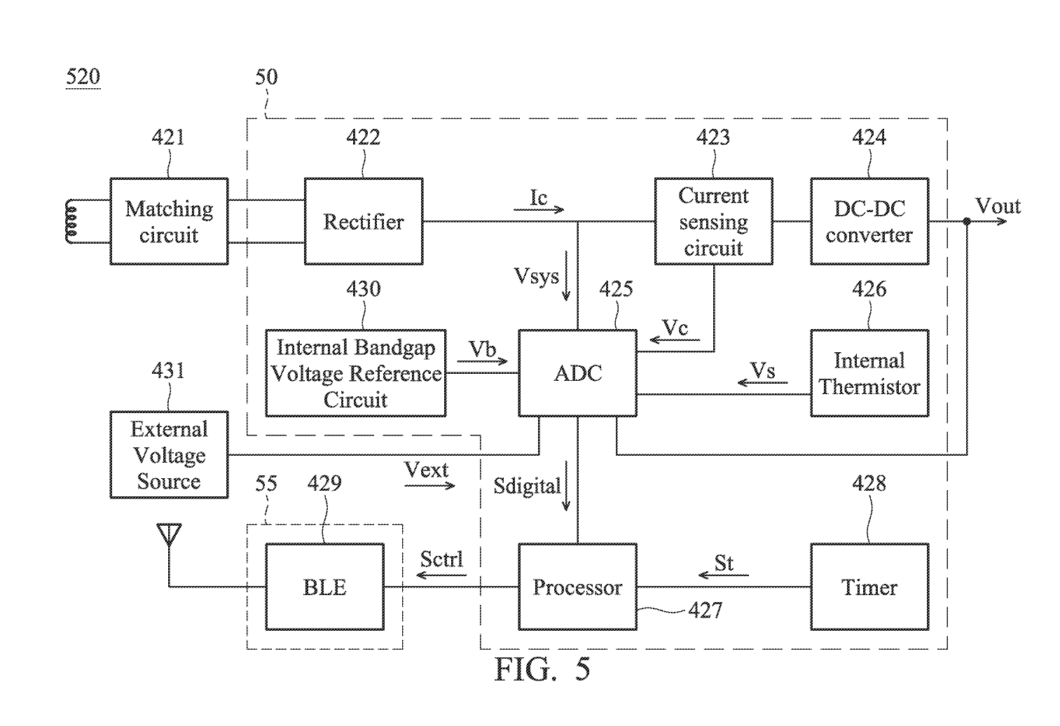

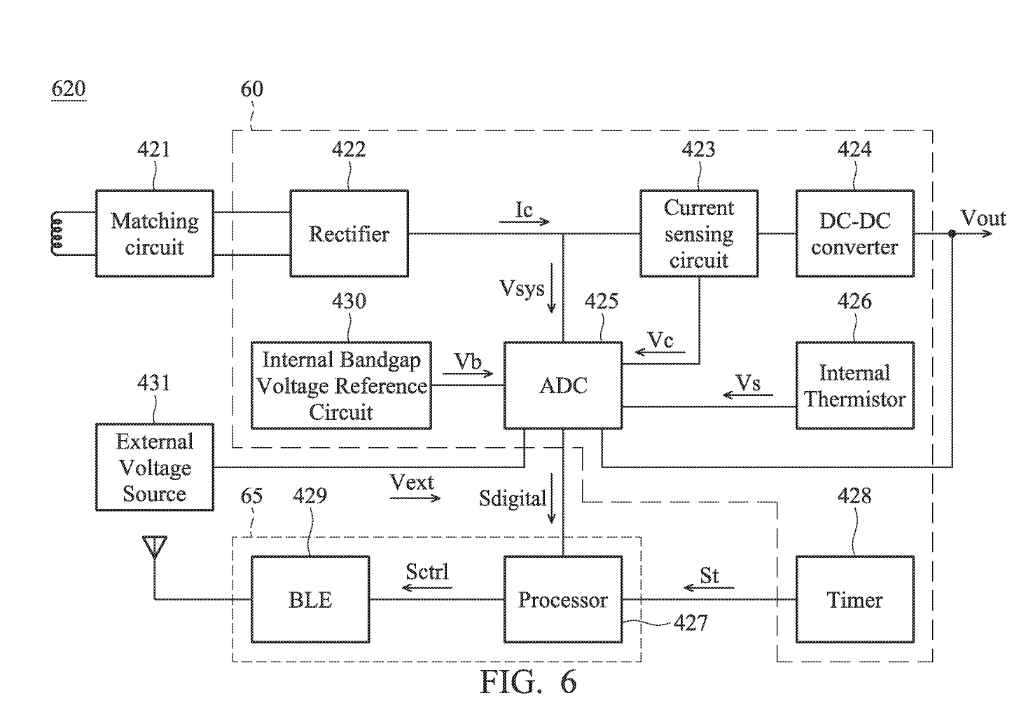

FIG. 5 is a block diagram of a wireless power receiver device according to another embodiment of the invention. Most of the elements comprised in the wireless power receiver device 520 are the same as the elements comprised in the wireless power receiver device 420. For detailed descriptions, reference may be made to FIG. 4 and are omitted here for brevity.

In this embodiment, the rectifier 422, the current sensing circuit 423, the DC-DC converter 424, the ADC 425, the internal thermistor 426, the processor 427, the timer 428 and the internal bandgap voltage reference circuit 430 may be integrated in one chip, such as the wireless power receiver chip 50 shown in FIG. 5, and the BLE module 429 may be comprised in another chip or device, such as a wireless communications chip (or, a BLE chip) or a wireless communications device (or, a BLE device) 55 shown in FIG. 5. Note that in this embodiment, another processor may also be comprised in the BLE module 429 or the corresponding chip or device, and the invention should not be limited to what is shown in FIG. 5.

FIG. 6 is a block diagram of a wireless power receiver device according to yet another embodiment of the invention. In this embodiment, the rectifier 422, the current sensing circuit 423, the DC-DC converter 424, the ADC 425, the internal thermistor 426, the timer 428 and the internal bandgap voltage reference circuit 430 may be integrated in one chip, such as a wireless power receiver chip 60 shown in FIG. 6, and the processor 427 and the BLE module 429 may be comprised in another chip or device, such as a wireless communications chip (or, a BLE chip) or a wireless communications device (or, a BLE device) 65 shown in FIG. 6. Note that in this embodiment, another processor may also be comprised in the wireless power receiver chip 60, and the invention should not be limited to what is shown in FIG. 6.

In addition, in the embodiment shown in FIG. 6, the processor 427 may receive a signal comprising information regarding a system voltage Vsys of the wireless power receiver device, an amount of charging current of the wireless power receiver device, an internal temperature of the wireless power receiver device, a bandgap voltage of the wireless power receiver device, an external voltage of the wireless power receiver device, and/or a current tick time value of a timer of the wireless power receiver device from the wireless power receiver chip 60, and use the information to correspondingly determine the delay time as discussed above.

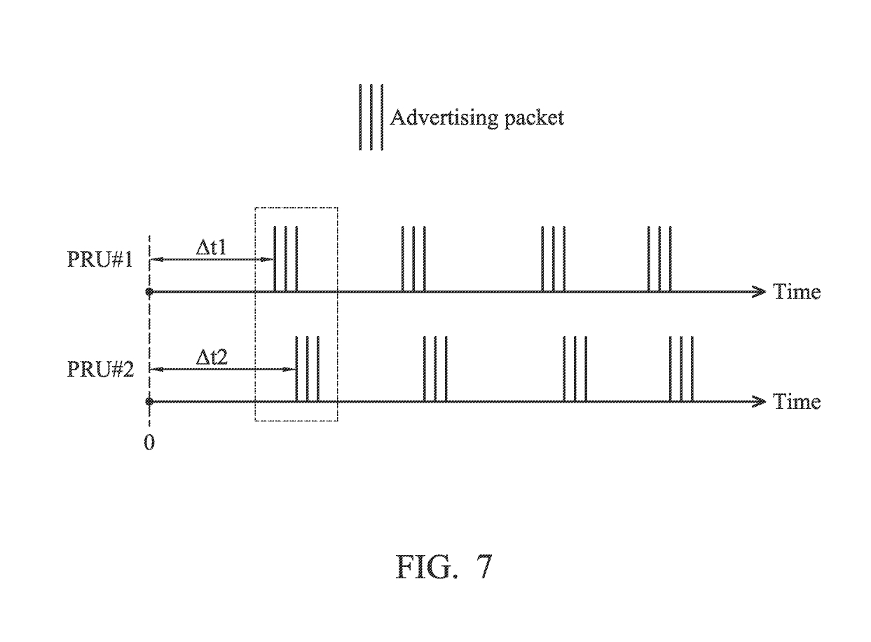

FIG. 7 shows the timing diagrams for different power receiving units to transmit the advertising packets according an embodiment of the invention. In the embodiment of the invention, the power receiving units PRU#1 and PRU#2 may be the power receiving units comprising the wireless power receiver device 420, 520 or 620 as discussed above. As shown in FIG. 7, by applying the delay control mechanism as illustrated above, the power receiving unit PRU#1 may delay its first advertising packet by Δt1 and the power receiving unit PRU#2 may delay its first advertising packet by Δt2, where Δt1 may be different from Δt2. In this manner, the advertising packet collision can be avoided or the possibility of packet collision can be reduced. As a result, the engaging successful rate between the wireless power transmitter device (or PTU) and the power receiving units PRU#1, PRU#2 can be increased significantly (e.g., both the power receiving units PRU#1, PRU#2 can be successfully engaged with wireless power transmitter device PTU during the long beacon frame), and thereby improving wireless charging performance.

Although the above descriptions use a BLE module as a communications module or use a BLE communications device or chip as a wireless communications device or chip, it is for illustrative purpose rather than limitation. In other words, the present invention is not limited to using BLE, other communications modules such as WiFi, NFC and Zigbee can also provide the similar function. The processor 427 can control the delay amount of a first packet or a first advertising packet that the communications module or the wireless communications device or chip sends for establishing wireless connection or communications between PTU and PRU. The packet collision possibility can therefore be reduced, and the wireless charging performance can be improved.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless power receiver device capable of performing wireless power reception, comprising:
a processor, determining a delay time and generating a delay control signal comprising information regarding the delay time; and
a communications module, coupled to the processor and capable of providing wireless communications service,
wherein the communications module receives the delay control signal and delays a time to transmit a first packet utilized for establishing communications between the wireless power receiver device and a wireless power transmitter device according to the delay time.

2. The wireless power receiver device as claimed in claim 1, wherein the first packet is transmitted in response to a beacon frame received from the wireless power transmitter device.

3. The wireless power receiver device as claimed in claim 1, wherein the processor randomly/pseudo-randomly determines the delay time.

4. The wireless power receiver device as claimed in claim 1, further comprising:
an analog-to-digital converter (ADC), coupled to the processor and generating a digital signal,
wherein the ADC provides the digital signal to the processor and the processor determines the delay time according to the digital signal.

5. The wireless power receiver device as claimed in claim 4, wherein the processor uses the digital signal as a random seed to generate a random/pseudo-random number as the delay time.

6. The wireless power receiver device as claimed in claim 4, further comprising:
a rectifier, receiving an inducing current and rectifying the inducing current to generate a system voltage,
wherein the ADC further receives the system voltage and analog-to-digital converts the system voltage to generate the digital signal.

7. The wireless power receiver device as claimed in claim 4, further comprising:
a current sensing circuit, receiving a charging current and sensing an amount of the charging current to generate a sensed voltage,
wherein the ADC further receives the sensed voltage and analog-to-digital converts the sensed voltage to generate the digital signal.

8. The wireless power receiver device as claimed in claim 4, further comprising:
an internal thermistor, sensing an internal temperature to generate a sensed voltage,
wherein the ADC further receives the sensed voltage and analog-to-digital converts the sensed voltage to generate the digital signal.

9. The wireless power receiver device as claimed in claim 4, further comprising:
an internal bandgap voltage reference circuit, providing a bandgap voltage,
wherein the ADC further receives the bandgap voltage and analog-to-digital converts the bandgap voltage to generate the digital signal.

10. The wireless power receiver device as claimed in claim 4, wherein the ADC further receives an external voltage and analog-to-digital converts the external voltage to generate the digital signal.

11. The wireless power receiver device as claimed in claim 1, further comprising:
a timer,
wherein the processor determines the delay time according to a current tick time value of the timer.

12. The wireless power receiver device as claimed in claim 11, wherein the processor uses the current tick time value as a random seed to generate a random/pseudo-random number as the delay time.

13. A wireless power receiver device capable of performing wireless power reception and communicating with a communications device, comprising:
an analog-to-digital converter (ADC), generating a digital signal according to an analog voltage, wherein
the digital signal or a tick time value generated from a timer is utilized to determine a delay time for the communications device to delay a time to transmit a first packet utilized for establishing communications between the wireless power receiver device and a wireless power transmitter device.

14. The wireless power receiver device as claimed in claim 13, wherein the delay time is determined randomly or pseudo-randomly.

15. The wireless power receiver device as claimed in claim 14, wherein the digital signal or the tick time value is utilized as a random seed to generate a random/pseudo-random number as the delay time.

16. The wireless power receiver device as claimed in claim 13, further comprising:
a rectifier, receiving an inducing current and rectifying the inducing current to generate a system voltage,
wherein the system voltage is provided to the ADC as the analog voltage.

17. The wireless power receiver device as claimed in claim 16, further comprising:
a current sensing circuit, receiving a charging current and sensing an amount of the charging current to generate a sensed voltage,
wherein the sensed voltage is provided to the ADC as the analog voltage.

18. The wireless power receiver device as claimed in claim 13, further comprising:
an internal thermistor, sensing an internal temperature to generate a sensed voltage,
wherein the sensed voltage is provided to the ADC as the analog voltage.

19. The wireless power receiver device as claimed in claim 13, further comprising:
an internal bandgap voltage reference circuit, providing a bandgap voltage,
wherein the bandgap voltage is provided to the ADC as the analog voltage.

20. The wireless power receiver device as claimed in claim 13, wherein the ADC further receives an external voltage as the analog voltage.

21. The wireless power receiver device as claimed in claim 13, further comprising:
the timer,
wherein the delay time is determined according to a current tick time value of the timer.

22. The wireless power receiver device as claimed in claim 21, wherein the current tick time value is used as a random seed to generate a random/pseudo-random number as the delay time.

23. The wireless power receiver device as claimed in claim 21, further comprising a processor, determining the delay time, generating a delay control signal comprising information regarding the delay time, and transmitting the delay control signal to the communications device.

24. A wireless communications device capable of providing wireless communications service and coupled to a wireless power receiver device to facilitate the wireless power receiver device to establish a wireless communications with a wireless power transmitter device, comprising:
a processor, generating a delay control signal comprising information regarding a delay time; and
a communications module, coupled to the processor and capable of providing wireless communications service,
wherein the communications module receives the delay control signal and delays a time to transmit a first packet utilized for establishing the wireless communications between the wireless power receiver device and the wireless power transmitter device according to the delay time, and
wherein the first packet is transmitted in response to a beacon frame received from the wireless power transmitter device.

25. The wireless communications device as claimed in claim 24, wherein the processor randomly/pseudo-randomly determines the delay time.

26. The wireless communications device as claimed in claim 24, wherein the processor further receives a signal comprising information regarding a system voltage of the wireless power receiver device and correspondingly generates the delay control signal.

27. The wireless communications device as claimed in claim 24, wherein the processor further receives a signal comprising information regarding an amount of a charging current of the wireless power receiver device and correspondingly generates the delay control signal.

28. The wireless communications device as claimed in claim 24, wherein the processor further receives a signal comprising information regarding an internal temperature of the wireless power receiver device and correspondingly generates the delay control signal.

29. The wireless communications device as claimed in claim 24, wherein the processor further receives a signal comprising information regarding a bandgap voltage of the wireless power receiver device and correspondingly generates the delay control signal.

30. The wireless communications device as claimed in claim 24, wherein the processor further receives a signal comprising information regarding an external voltage of the wireless power receiver device and correspondingly generates the delay control signal.

31. The wireless communications device as claimed in claim 24, wherein the processor further receives a timer signal comprising information regarding a current tick time value of a timer of the wireless power receiver device and correspondingly generates the delay control signal.
